(19) United States
(12) Patent Application Publication
(10) Pub. No.: US 2026/0366664 A1
(43) Pub. Date: Nov. 19, 2026

(54) FLANGE FOR A DOUBLE-WALL PIPELINE

(71) Applicant: Airbus Operations (S.A.S.), Toulouse (FR)

(72) Inventors: Yannick Cazabonne, Toulouse (FR); Gilles Chaulet, Toulouse (FR)

(21) Appl. No.: 19/644,176

(22) Filed: Apr. 10, 2026

(30) Foreign Application Priority Data
May 15, 2025 (FR) FR2505187

(51) Int. Cl. F16L 39/00

(52) U.S. Cl. CPC F16L 39/005

(57) ABSTRACT

A flange for a double-wall pipeline and including an outer component having an outer barrel, inner spacers secured to the outer barrel and extending towards the inside of the outer barrel, and an outer collar secured to the outer barrel and extending towards the outside of the outer barrel, the outer barrel being intended to be fastened to an outer pipe, an inner component including an inner barrel, outer spacers secured to the inner barrel and extending towards the outside of the inner barrel, the inner barrel being housed in the outer barrel and being intended to be fastened to an inner pipe, and fasteners ensuring fastening of each inner spacer with an outer spacer. With such a flange, cracks cannot propagate from one component to another.

### TECHNICAL FIELD

The disclosure herein relates to a flange intended to be fastened at the end of a double-wall pipeline. The disclosure herein also relates to a connection assembly comprising at least one such flange and to an aircraft comprising at least one such connection.

### BACKGROUND

To transport a fluid, it is known to use pipelines. To prevent the fluid from spreading out of the pipelines in the event of a leak, it is known to use double-wall pipelines. A double-wall pipeline comprises an outer pipe and an inner pipe fastened to the inside of the outer pipe.

To fasten two double-wall pipelines in the extension of one another, it is known to use a flange 800 like that shown in FIG. 8 and which comprises an outer barrel 802 and an inner barrel 804 housed in the outer barrel 802. The inner barrel 804 is fastened to the inner pipe and the outer barrel 802 is fastened to the outer pipe. The fluid to be transported, such as kerosene or dihydrogen, flows through the inner pipe and the inner barrel 804. The volume between the inner pipe, or the inner barrel 804, and the outer pipe, or the outer barrel 802, respectively, can be filled with an inert fluid such as dinitrogen in order to neutralize the fluid to be transported in the event of a leak.

The flange 800 is fastened to a similar flange 800 so as to extend the pipelines and, when the pipelines have to pass through a wall, a flange 800 is fastened on either side of the wall.

The flange 800 also comprises a plate 806 which extends perpendicularly to the axes of the barrels 802 and 804 and which is secured to the two barrels 802 and 804.

The plate 806 has a central bore 808 which is delimited by the inner barrel 804 and which allows the passage of the fluid to be transported.

The plate 806 has, between the inner barrel 804 and the outer barrel 802, a plurality of peripheral bores 810 which allow the passage of the inert fluid.

To avoid mixing between the two fluids and leaks to the outside, seals are placed in grooves 812a, a central groove 812a encircling the central bore 808 while remaining inside the peripheral bores 810 and a peripheral groove 812b encircling the peripheral bores 810.

Such a flange 800 is thus made up of a single piece and if initiation of a crack 814 appears in the plate 806, this crack 814 can propagate through the plate 806 with the risk of opening a passage for the fluid to be transported between the inside of the inner barrel 804 and the outside.

It is therefore desirable to find an arrangement which limits the risks of crack propagation and therefore leaks.

### SUMMARY

An object of the disclosure herein is a flange to be fastened to an end of a double-wall pipeline which does not have the problems of the prior art and which in particular limits the risks of propagation of a crack.

To this end, a flange is disclosed for a double-wall pipeline comprising an outer pipe and an inner pipe, the flange comprising:
an outer component comprising an outer barrel, inner spacers secured to the outer barrel and extending towards the inside of the outer barrel, and an outer collar secured to the outer barrel and extending towards the outside of the outer barrel, the outer barrel being intended to be fastened to the outer pipe,
an inner component comprising an inner barrel, outer spacers secured to the inner barrel and extending towards the outside of the inner barrel, the inner barrel being housed in the outer barrel and being intended to be fastened to the inner pipe, and
fasteners ensuring the fastening of each inner spacer with an outer spacer.

With such a flange, cracks cannot propagate from one component to another. Advantageously, the inner spacers and the outer spacers are shaped so as to allow the outer spacers to pass through the inner spacers.

Advantageously, the inner component comprises a central groove which encircles the inner barrel, and the flange comprises a central seal arranged in the central groove.

Advantageously, the outer collar comprises a peripheral groove which encircles the outer barrel, and the flange comprises a peripheral seal arranged in the peripheral groove.

Advantageously, the outer component has a channel which ensures fluidic communication between the outside of the outer barrel and the volume between the outer barrel and the inner barrel.

The subject matter herein also discloses a connection assembly comprising:
a wall pierced by a bore,
two flanges according to any of the preceding variants disposed on either side of the wall, each inner barrel fitting into the bore, and
clamps ensuring the clamping of each flange against the wall.

The disclosure herein also proposes a connection assembly comprising:
a wall pierced by a bore,
a flange according to any of the preceding variants disposed against one side of the wall, the inner barrel fitting into the bore,
a complementary component comprising a complementary barrel intended to be fastened to a complementary pipe and a disc extending around the complementary barrel and disposed against another side of the wall, the complementary barrel fitting into the bore, and
clamps ensuring the clamping of the flange and of the disc against the wall.

The subject matter herein also discloses an aircraft comprising at least one connection assembly according to any of the preceding variants.

### BRIEF DESCRIPTION OF THE DRAWINGS

The features of the disclosure herein that are mentioned above, along with others, will become more clearly apparent upon reading the following description of one example embodiment, the description being given with reference to the appended drawings, in which:

FIG. 1 is a side view of an aircraft comprising at least one connection assembly using a flange according to the disclosure herein;

FIG. 2 is a perspective view of a flange according to the disclosure herein;

FIG. 3 is a front view of the flange according to the disclosure herein in an insertion position;

FIG. 4 is a front view of the flange according to the disclosure herein in a use position;

FIG. 5 is a side view in section on an axial plane of the flange according to the disclosure herein;

FIG. 6 is a side view in section on an axial plane of a connection assembly according to a first embodiment of the disclosure herein;

FIG. 7 is a perspective view in section on an axial plane of a connection assembly according to a second embodiment of the disclosure herein; and

FIG. 8 is a perspective view in section of a flange of the prior art.

### DETAILED DESCRIPTION

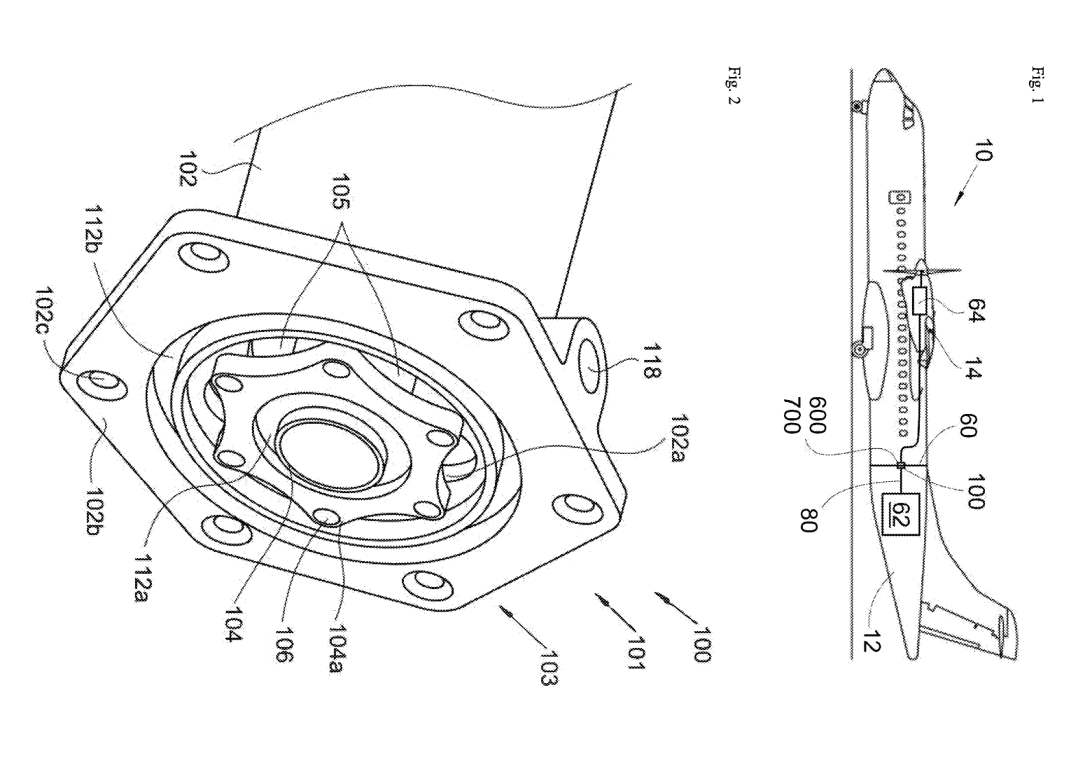

FIG. 1 shows an aircraft 10 which here comprises, on either side of a fuselage 12, a wing 14 to which a consumer system 64 supplied with fuel from a tank 62 is fastened. The fuel may be kerosene or dihydrogen. In the case of kerosene, the consumer system 64 is a combustion engine, such as a turbomachine. In the case of dihydrogen, the consumer system 64 may be a combustion engine, such as a turbomachine, or a fuel cell. Of course, depending on the case, the tank 62 and the consumer system 64 could be disposed elsewhere in the aircraft 10.

Between the tank 62 and the consumer system 64, the aircraft 10 comprises a main double-wall pipeline. The main pipeline here passes through a wall 60 of the aircraft 10 at a bore which the wall 60 has for this purpose. There is then a double-wall pipeline 80 on either side of the wall 60 and at the wall 60, the end of each double-wall pipeline 80 has a flange 100 according to the disclosure herein. Each flange 100 ensures the fastening of the equipped end to the wall 60, but it is also possible to lengthen a first double-wall pipeline 80 with a second double-wall pipeline 80 by fastening two flanges 100 directly against one another.

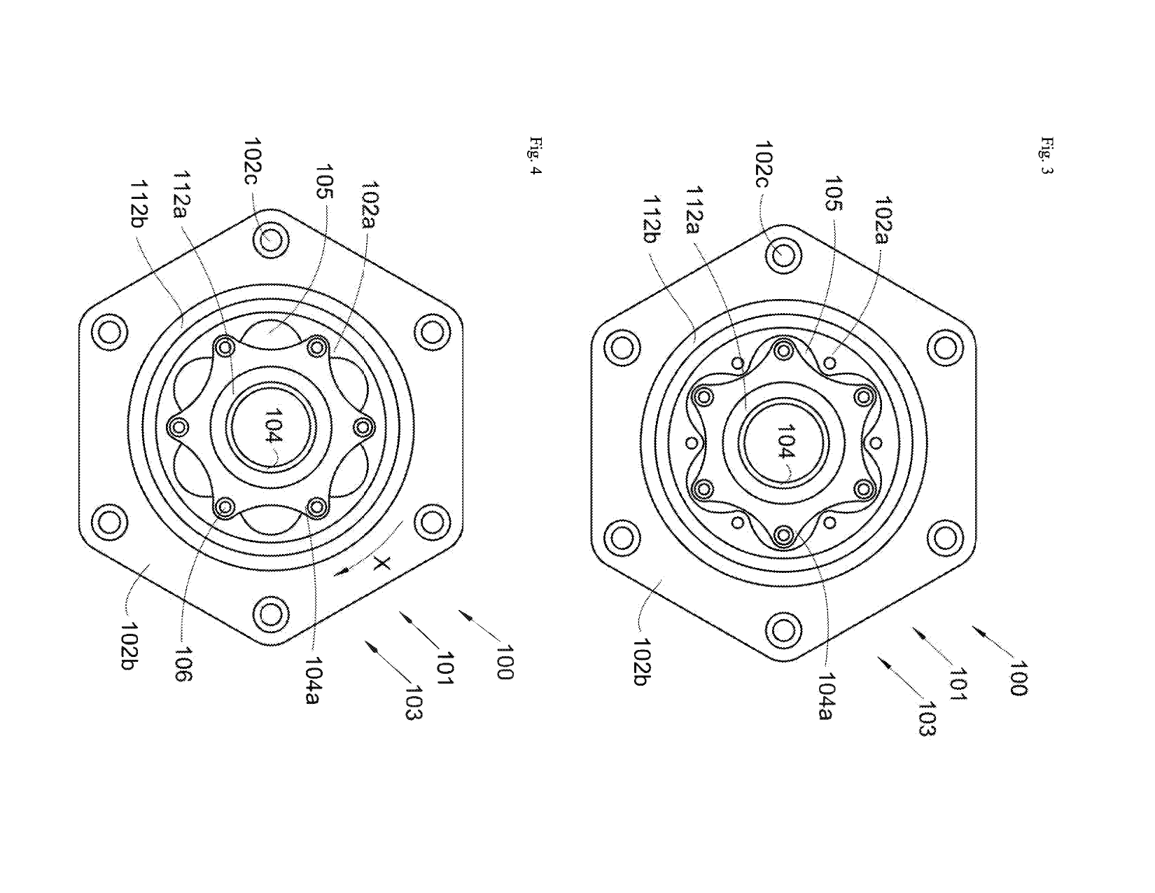

FIGS. 2 and 5 show the flange 100 according to the disclosure herein in the use position.

The double-wall pipeline 80 comprises an outer pipe 202 and an inner pipe 204 which is housed in the outer pipe 202. Each pipe 202, 204 may be rigid or flexible. The fluid to be transported (kerosene, dihydrogen, etc.) circulates in the inner pipes 204 while an inert fluid (air, dinitrogen, etc.) can be placed between the two pipes 202 and 204.

The flange 100 comprises an outer component 101 and an inner component 103.

The outer component 101 comprises an outer barrel 102 which is secured to the outer pipe 202. The inner component 103 comprises an inner barrel 104 which is secured to the inner pipe 204. The pipe 202, 204 is fastened to the associated barrel 102, 104 in any of the known ways, for example with the aid of a clamp ring, by welding, etc.

The inner barrel 104 is thus housed in the outer barrel 102.

The outer component 101 also comprises inner spacers 102a which are secured to the outer barrel 102 and which extend towards the inside of the outer barrel 102.

At the same time, the inner component 103 comprises outer spacers 104a which are secured to the inner barrel 104 and which extend towards the outside of the inner barrel 104.

The flange 100 also comprises fasteners 106 which ensure the fastening of each inner spacer 102a with an outer spacer 104a. The fasteners 106 are, for example, rivets. The fasteners 106 are removable in the sense that it is possible to separate the inner component 103 and the outer component 101 without damaging them, for example by removing the rivets.

The outer component 101 also comprises an outer collar 102b which is secured to the outer barrel 102 and which extends towards the outside of the outer barrel 102 and which is provided to allow the fastening of the outer component 101 to the wall 60 or to an outer collar of another similar flange. Here, the outer collar 102b has apertures 102c for placing clamping screws.

With such a flange 100, crack initiation cannot be transmitted from one component 101, 103 to the other 103, 101 since they are physically separated.

The spacers 102a and 104a are at the open end of the barrel 102, 104 concerned and the number of spacers 102a and 104a depends inter alia on the diameters of the barrels 102 and 104.

As can be seen in FIG. 2, when the components 101 and 103 are in the use position, there are passages 105 between the spacers 102a and 104a to allow the passage of a fluid if necessary, as for the peripheral bores 810 of the prior art.

To facilitate the placing of the inner component 103 in the outer component 101, the inner spacers 102a and the outer spacers 104a are shaped so as to allow the outer spacers 104a to pass through the inner spacers 102a.

In the embodiment of the disclosure herein, the outer spacers 104a take the form of a ring with outwardly oriented points pierced with holes for the passage of the fasteners 106. The points thus form the outer spacers 104a.

In the same way, in the embodiment of the disclosure herein, the inner spacers 102a take the form of a ring with inwardly oriented points pierced with holes for the passage of the fasteners 106. The points thus form the inner spacers 102a.

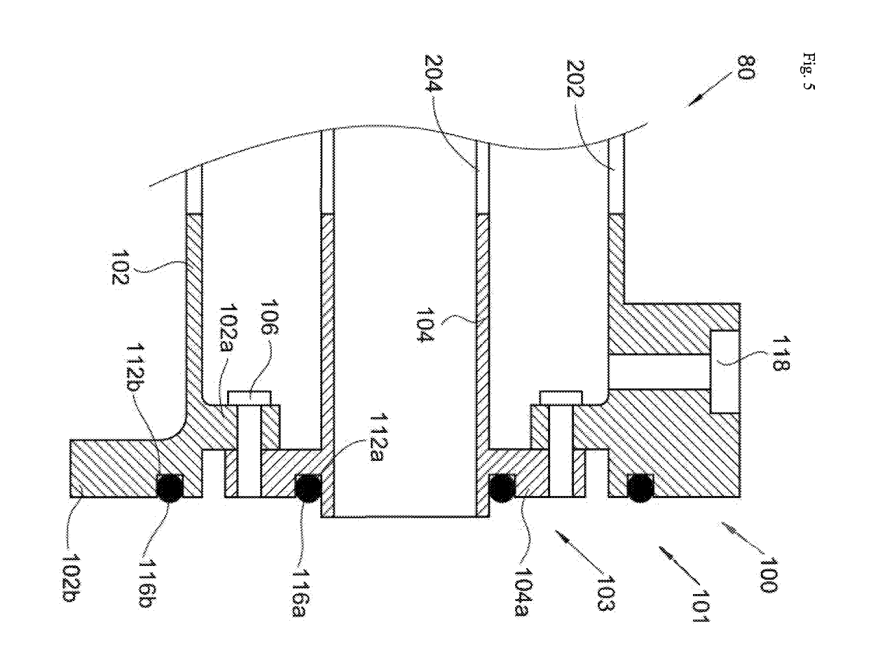

As shown in FIG. 3, the shape of the outer spacers 104a and the shape of the inner spacers 102a are such that, in an insertion position, the outer spacers 104a can pass between the inner spacers 102a. Then, after a rotation X visible in FIG. 4, each outer spacer 104a is located facing an inner spacer 102a and can be fastened there by the fasteners 106 in a use position.

Of course, the spacers 102a and 104a may take other suitable forms.

To ensure sealing, the inner component 103 comprises a central groove 112a which encircles the inner barrel 104, in particular its open end, and the flange 100 comprises a central seal 116a which is arranged in the central groove 112a.

In the same way, the outer collar 102b comprises a peripheral groove 112b which encircles the outer barrel 102, in particular its open end, and the flange 100 comprises a peripheral seal 116b which is arranged in the peripheral groove 112b.

These seals 116a-b come against the wall 60 or against the same seal when two flanges 100 are fastened directly against one another.

In the embodiment of the disclosure herein shown in FIGS. 2 and 5, the outer component 101 has a channel 118 which ensures fluidic communication between the outside of the outer barrel 102 and the volume between the outer barrel 102 and the inner barrel 104. Such a channel 118 allows the installation of a sensor or the introduction of a fluid between the two barrels and the two pipes.

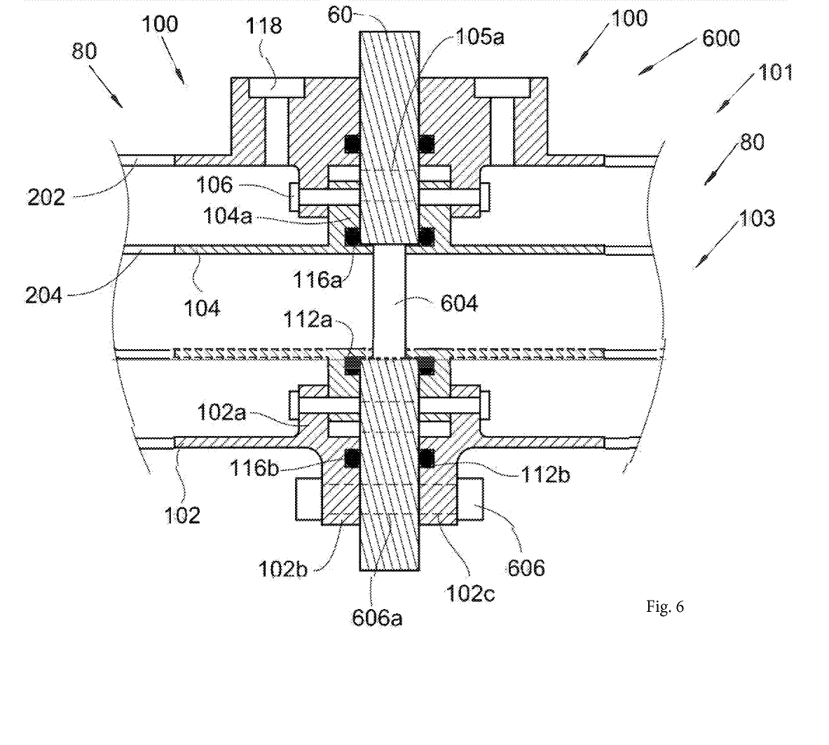

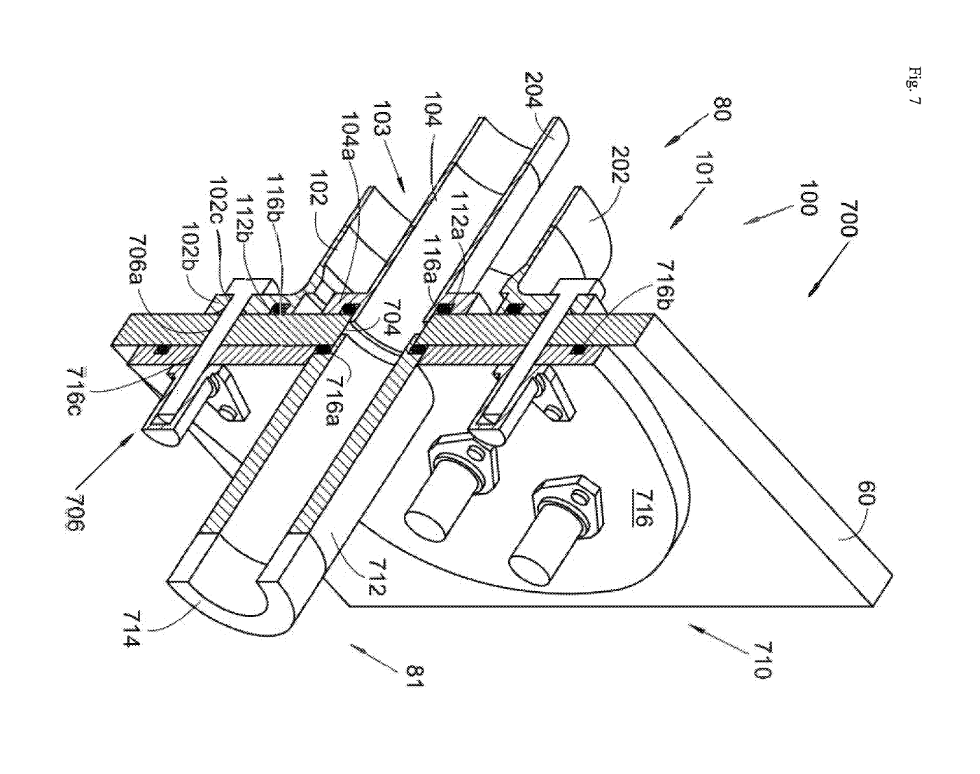

FIG. 6 shows a connection assembly 600 according to a first arrangement which comprises a wall 60 pierced by a bore 604 and two flanges 100 according to the disclosure herein.

The two flanges 100 are disposed on either side of the wall 60 and each inner barrel 104 fits into the bore 604 to ensure fluidic continuity for the fluid circulating in the double-wall pipeline 80.

The connection assembly 600 also comprises clamps 606 which ensure the clamping of each flange 100 against the wall 60. The clamps 606 here take the form of screwed fasteners which are arranged in the apertures 102c in the outer collar 102b of each flange 100 and which pass through the wall 60 at through-holes 606a (seen in dashed lines) provided for this purpose.

Each central seal 116a comes to bear against a face of the wall 60 around the bore 604. In the same way, each peripheral seal 116b comes to bear against a face of the wall 60.

The wall 60 may also have through-holes 105a (seen in dashed lines) aligned with the passages 105 between the spacers 102a and 104a to allow the fluid which is between the barrels 102 and 104 to flow on either side of the wall 60.

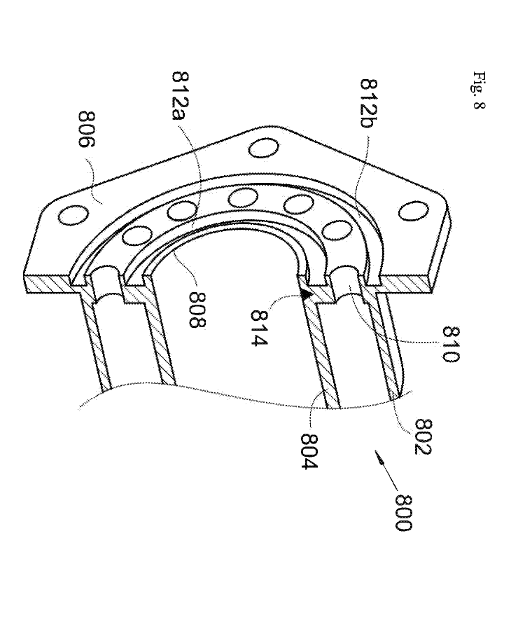

FIG. 7 shows a connection assembly 700 according to a second arrangement which comprises a wall 60 pierced by a bore 704, a flange 100 according to the disclosure herein and a complementary component 710 associated with a single-wall pipeline 81 comprising a complementary pipe 714.

Such a connection assembly 700 allows the passage from a double-wall pipeline 80 to a single-wall pipeline 81.

The flange 100 is disposed on one side of the wall 60 against one of the faces of the wall 60 and the inner barrel 104 fits into the bore 704.

The complementary component 710 comprises a complementary barrel 712 which is fastened to the complementary pipe 714 and a disc 716 which extends around the complementary barrel 712 and which is disposed against the other side of the wall 60 against the other face of the wall 60.

The complementary barrel 712 fits into the bore 704 to ensure fluidic continuity for the fluid circulating in the inner pipe 204.

The connection assembly 700 also comprises clamps 706 which ensure the clamping of the flange 100 and of the disc 716 against the wall 60.

The clamps 706 here take the form of screwed fasteners which are arranged in the apertures 102c in the outer collar 102b of the flange 100 and in apertures 716c in the disc 716 and which pass through the wall 60 at through-holes 706a provided for this purpose.

The complementary component 710 also comprises a central seal 716a bearing against a face of the wall 60 around the bore 704 and a peripheral seal 716b around the apertures 716c in the disc 716.

For the flange 100, the central seal 116a comes to bear against the other face of the wall 60 around the bore 704 and, in the same way, the peripheral seal 116b comes to bear against the other face of the wall 60.

To avoid leaks at the clamps 706, the latter comprise a clamping screw and a cap nut fastened to the disc 716.

The aircraft 10 thus comprises at least one connection assembly 600 according to the first arrangement or at least one assembly 700 according to the second arrangement.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or "comprising" do not exclude other elements or steps, the terms "a", “an” or "one" do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A flange for a double-wall pipeline comprising an outer pipe and an inner pipe, the flange comprising:
an outer component comprising an outer barrel, inner spacers secured to the outer barrel and extending towards an inside of the outer barrel, and an outer collar secured to the outer barrel and extending towards an outside of the outer barrel, the outer barrel being configured to be fastened to the outer pipe;
an inner component comprising an inner barrel, outer spacers secured to the inner barrel and extending towards an outside of the inner barrel, the inner barrel being housed in the outer barrel and being configured to be fastened to the inner pipe; and
fasteners ensuring fastening of each inner spacer with an outer spacer.

2. The flange according to claim 1, wherein the inner spacers and the outer spacers are shaped to allow the outer spacers to pass through the inner spacers.

3. The flange according to claim 1, wherein the inner component comprises a central groove which encircles the inner barrel, and wherein the flange comprises a central seal in the central groove.

4. The flange according to claim 1, wherein the outer collar comprises a peripheral groove which encircles the outer barrel, and wherein the flange comprises a peripheral seal in the peripheral groove.

5. The flange according to claim 1, wherein the outer component has a channel which ensures fluidic communication between the outside of the outer barrel and a volume between the outer barrel and the inner barrel.

6. A connection assembly comprising:
a wall pierced by a bore;
two flanges according to claim 1 disposed on either side of the wall, each inner barrel fitting into the bore; and
clamps ensuring clamping of each flange against the wall.

7. A connection assembly comprising:
a wall pierced by a bore;
a flange according to claim 1 disposed against one side of the wall, the inner barrel fitting into the bore;
a complementary component comprising a complementary barrel to be fastened to a complementary pipe and a disc extending around the complementary barrel and disposed against another side of the wall, the complementary barrel fitting into the bore; and
clamps ensuring clamping of the flange and of the disc against the wall.

8. An aircraft comprising at least one connection assembly according to claim 6.

9. An aircraft comprising least one connection assembly according to claim 7.
